(19) United States
(12) Patent Application Publication
(10) Pub. No.: US 2020/0044368 A1
(43) Pub. Date: Feb. 6, 2020

(54) Grounding Connector

(71) Applicant: Panduit Corp., Tinley Park, IL (US)

(72) Inventors: David K. Osenga, Munster, IN (US); Robert G. Bucciferro, Shorewood, IL (US)

(73) Assignee: Panduit Corp., Tinley Park, IL (US)

(21) Appl. No.: 16/531,589

(22) Filed: Aug. 5, 2019

Related U.S. Application Data
(60) Provisional application No. 62/714,930, filed on Aug. 6, 2018.

(51) Int. Cl. H01R 4/18; H01R 4/64

(52) U.S. Cl. CPC H01R 4/186; H01R 4/646

(57) ABSTRACT

A grounding connector for securing a wire or rod therein. The grounding connector has a body including a first side, a second side, and a mid-section extending therebetween, with an opening extending through the body from the first side to the second side. The body of the grounding connector includes a lock joint configured to join the grounding connector with a second grounding connector, with the lock joint including a recess inset into the mid-section of the body and a protrusion adjacent the recess extending from the mid-section.

### CROSS REFERENCE TO RELATED APPLICATIONS

This application claims priority to U.S. Provisional Application No. 62/714,930, filed Aug. 6, 2018, the subject matter of which is hereby incorporated by reference in its entirety.

### FIELD OF THE INVENTION

The present invention relates to a grounding connector for connecting two conductive elements together.

### BACKGROUND OF THE INVENTION

Grounding compression connectors, also referred to as FIG. 8 connectors, are used for connecting wire to grounding rods. FIG. 8 connectors typically include a solid copper extrusion that form two seamless rings of copper. These FIG. 8 connectors are typically manufactured using extrusion molding, thereby forming a unitary piece of copper configured in a FIG. 8 shape.

To install a FIG. 8 connector, a wire is inserted into one of the rings and a grounding rod is inserted into the other ring. The FIG. 8 connector is then crimped to secure the wire and grounding rod in place and form an electrical grounding path. An example of an existing FIG. 8 grounding connector is the Ground Rod Tap Connectors sold by Thomas & Betts.

Different combinations of FIG. 8 connectors must be manufactured to accommodate different sizes of wire and grounding rods within the rings. As such, FIG. 8 connectors must be manufactured with a range of different sized rings for the wire, paired with a range of different sized rings for the grounding rod. To accomplish this, a manufacturer must individually tool for manufacturing, each of the FIG. 8 connector combinations. Similarly, an installer must have each combination of sizes on-hand when utilizing a FIG. 8 connector in order to ensure the correct ring size for the wire and grounding rod combination.

### SUMMARY OF THE INVENTION

In one example, according to the teachings of the present invention, a grounding connector for securing a wire or rod therein may comprising a body including a first side and a second side and a mid-section extending therebetween, with an opening extending through the body from the first side to the second side, and with the body including a lock joint configured to join the grounding connector with a second grounding connector, the lock joint including a recess inset into the mid-section of the body and a protrusion adjacent the recess extending from the mid-section.

In one example, the lock joint of the grounding connector may be configured to slidably connect to a second grounding connector.

In one example, the opening of the grounding connector may be configured to accept a wire or rod.

In one example, the grounding connector may be configured to deform and reduce the diameter across at least a portion of the opening for securing the wire or rod therein.

In one example, the protrusion of the grounding connector may include a first outer wall extending from the body, an inner wall extending from the body, and a first base wall extending therebetween, with a first distance between the first outer wall and the inner wall along the base wall being greater than a second distance between the outer wall and the inner wall along the body.

In one example, the recess of the grounding connector may include a second outer wall extending into the body, the inner wall of the protrusion, and a second base wall extending therebetween, with a third distance between the second outer wall and the inner wall along the second base wall being greater than a fourth distance between the second outer wall and the inner wall along adjacent the second base wall.

In one example, according to the teachings of the present invention, a compression connector for securing wires or rods therein may comprising a first grounding connector including a body including a first side and a second side and a mid-section extending between, with an opening that extends through the body from the first side to the second side and the body including a first lock joint, and a second grounding connector may include a body including a first side and a second side and a mid-section extending between, with an opening that extends through the body from the first side to the second side and the body including a second lock joint; the first lock joint of the first grounding connector is removably mated to the second lock joint of the second grounding connector.

In one example, the opening of first grounding connector is larger than the opening of the second grounding connector.

In one example, the first and second lock joints of the compression connector may include a protrusion and a recess.

In one example, the protrusions of the compression connector extend out from the body and the recess resides within the body.

In one example, the first lock joint and second lock joint of the compression connector are configured to slidably mate.

In one example, the first lock joint of the first grounding connector may include a first recess inset into a mid-section of the body and a first protrusion adjacent the first recess extending from the mid-section.

In one example, the second lock joint of the second grounding connector may include a second recess inset into a mid-section of the body and a second protrusion adjacent the second recess extending from the mid-section.

In one example, the first protrusion and second protrusion of the compression connector may each include a first outer wall extending from the body, an inner wall extending from the body, and a first base wall extending therebetween, where a first distance between the first outer wall and the inner wall along the base wall is greater than a second distance between the outer wall and the inner wall along adjacent the second base wall.

In one example, the first recess and second recess of the compression connector may each include a second outer wall extending into the body, the inner wall of the protrusion, and a second base wall extending therebetween, where a third distance between the second outer wall and the inner wall along the second base wall is greater than a fourth distance between the second outer wall and the inner wall along the body.

In one example, according to the teachings of the present invention, a method of forming a compression connector may comprising joining a first lock joint of a first grounding connector to a second lock joint of a second grounding connector, inserting a wire into an opening in the first grounding connector, inserting a rod into an opening in the second grounding connector, crimping the joined first grounding connector and second grounding connector, and deforming the first grounding connector and the second grounding connector, thereby locking the first grounding connector to the second grounding connector and securing the wire and grounding rod in place.

### BRIEF DESCRIPTION OF THE DRAWINGS

Objects, features, and advantages of the present invention will become apparent upon reading the following description in conjunction with the drawing figures in which:

FIG. 1 depicts a top perspective view of an example grounding connector.

FIG. 2 depicts a top view of a plurality of differently sized grounding connectors.

FIG. 3 depicts a top perspective view of two offset grounding connectors of the grounding connector of FIG. 1.

FIG. 4 depicts a top perspective view of two mated grounding connectors.

FIG. 5 depicts a top perspective view of two crimped grounding connectors.

FIG. 6A depicts a top perspective view of two offset grounding connectors being slidably connected.

FIG. 6B depicts the grounding connectors of FIG. 6A in a mated configuration.

FIG. 7A depicts a top view of two grounding connectors being orientated for assembly.

FIG. 7B depicts a top view of the grounding connectors of FIG. 7A in a mated configuration.

FIB. 7C depicts a top view of the grounding connectors of FIG. 7B in a crimped configuration.

FIG. 8A depicts a top view of two grounding connectors being orientated for assembly.

FIG. 8B depicts a top view of the grounding connectors of FIG. 8A in a mated configuration.

FIG. 8C depicts a top view of the grounding connectors of FIG. 8B in a crimped configuration.

FIG. 9 depicts a top perspective view of two mated and crimped grounding connectors with a wire and rod installed therein.

FIG. 10 depicts a top perspective view of another example of two mated and crimped grounding connectors with a wire and rod installed therein.

FIG. 11 depicts top perspective view of an alternative example of two grounding connectors in a slidable configuration.

FIG. 12 depicts a top perspective view of a further alternative example of two grounding connectors in a slidable configuration.

### DETAILED DESCRIPTION

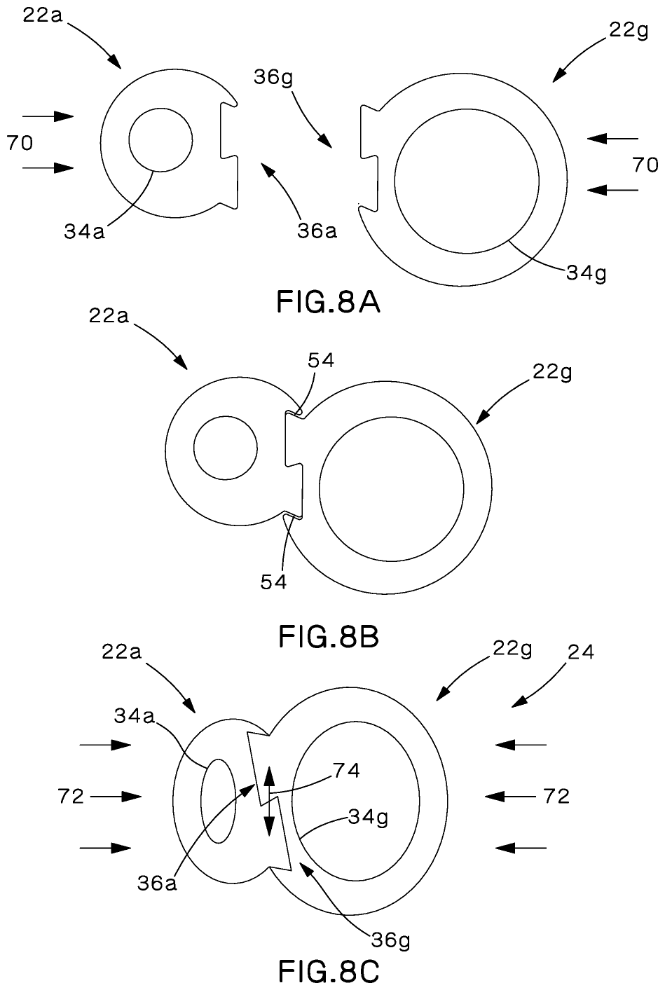

The disclosed grounding connector solves or improves upon one or more of the above noted and/or other problems and disadvantages with prior products and methods. The grounding connector of the present invention forms a grounding connector with a symmetrical locking feature that is configured to mate with a variety of sized grounding connectors including the locking feature. This enables grounding connectors with the same or different opening size to be mated together. The grounding connector simplifies the manufacture and installation of connecting a wire to a grounding rod or wire. The grounding connector of the present invention reduces the overall extrusion profile of the grounding connector during the manufacturing process. The grounding connector reduces the number of different size combinations needed to manufacture a connector. Further, the present invention reduces the number of different combinations of FIG. 8 connector sizes that an installer must have on hand to join a wire and rod.

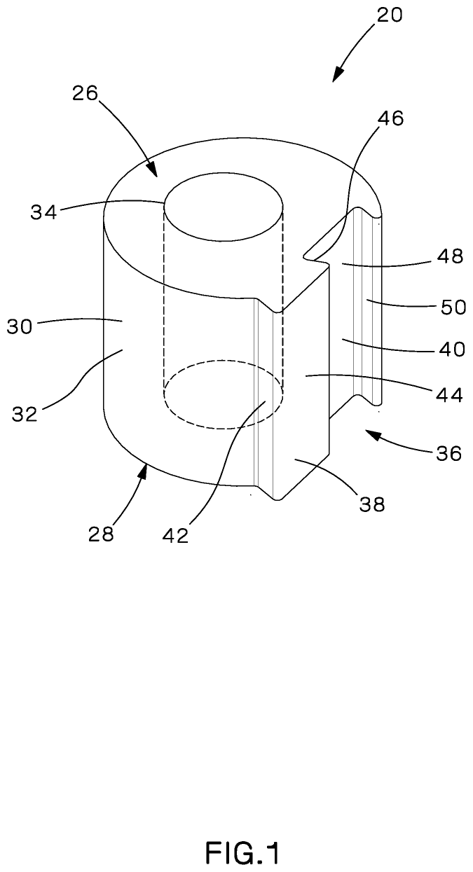

Turning to the drawings, FIG. 1 depicts one example of a grounding connector 20. The grounding connector 20 includes a first side 26, a second side 28, and a mid-section or side wall 30 extending therebetween. The first side 26 and second side 28 are planar surfaces with a C-shaped configuration. The side wall 30 is curved about the perimeter of the first side 26 and second side 28. The first side 26, second side 28, and side wall 30 form the body 32 of the grounding connector 20.

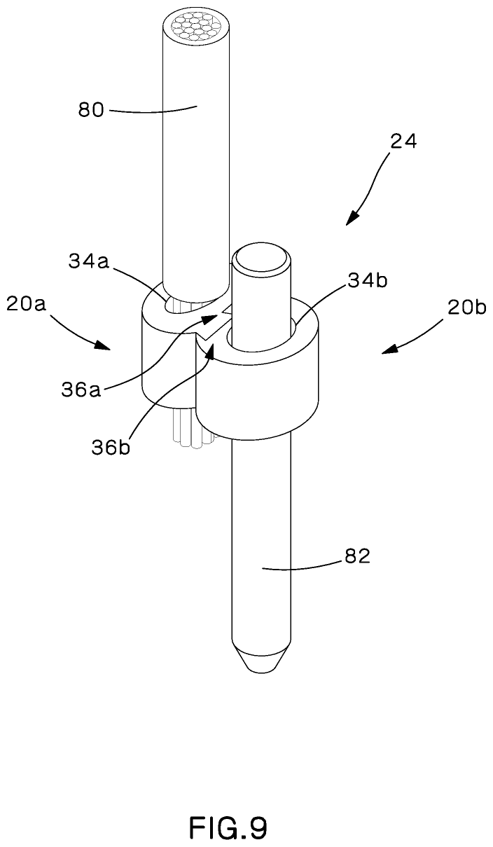

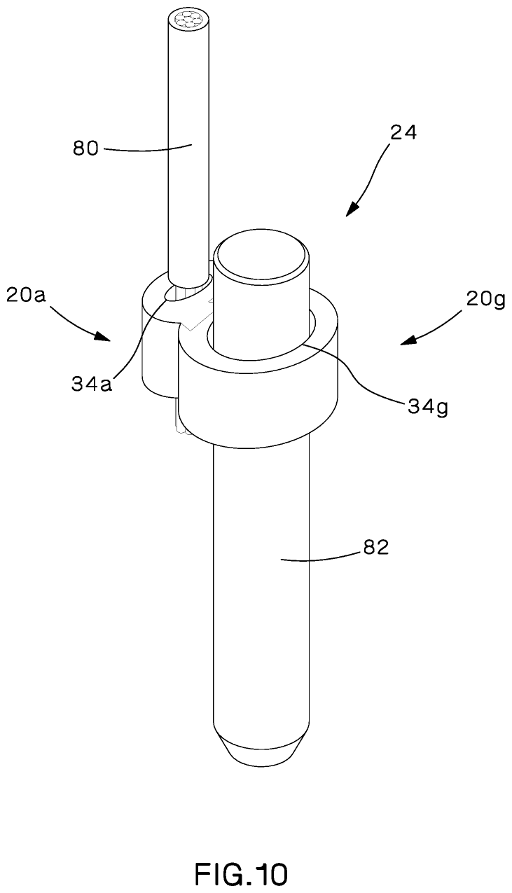

The body 32 of the grounding connector 20 includes a through opening 34. The opening 34 extends from the first side 26 to the second side 28. The size of the opening 34 is configured to accept a wire or grounding rod as described in relation to FIGS. 9 and 10 below.

The grounding connector 20 further includes a lock joint 36. The lock joint 36 includes the combination of a protrusion 38 and a recess 40. The protrusion 38 is disposed on the side wall 30 from the first side 26 to the second side 28. The protrusion 38 includes an outer wall 42 that extends out and away at an angle from the body 32 and side wall 30. A base wall 44 is disposed at an end of the outer wall 42. The base wall 44 extends across the body 32 of the grounding connector 20. An end of the base wall 44, opposite the outer wall 42, is an inner wall 46. The inner wall 46 extends between the base wall 44 and the body 32 at an angle. The angle of the outer wall 42 and inner wall 46 are mirrored walls including the same angle of extension away from the body 32.

The distance between the outer wall 42 and the inner wall 46 along the base wall 44 is greater than the distance between the outer wall 42 and the inner wall 46 along the body 32. The configuration of the outer wall 42, base wall 44, and inner wall 46 form a cross-sectional shape of a trapezoid.

Directly adjacent the protrusion 38 on the body 32 is the recess 40. The inner wall 46 of the protrusion 38 is shared with the recess 40. The recess 40 includes the inner wall 46 of the protrusion, which extends to a base 48. The base 48 extends across a portion of the body 32 to an outer wall 50 of the recess 40. The outer wall 50 extends outward at an angle from the base 48 to the side wall 30.

The distance between the outer wall 50 and the inner wall 46 along the base 48 is greater than the distance between the outer wall 50 and the inner wall 46 along the body 32. The configuration of the outer wall 50, base wall 48, and inner wall 46 form a cross-sectional shape of a trapezoid.

The shape and dimensions of the protrusion 38 are configured to correspond to the recess 40. The size and shape of the protrusion 38 of one grounding connector 20 is configured to allow the protrusion 38 to mate with the recess 40 of another grounding connector 20. This configuration allows the grounding connector 20 to be symmetrical and mate with another grounding connector 20 with the same lock joint 36 configuration.

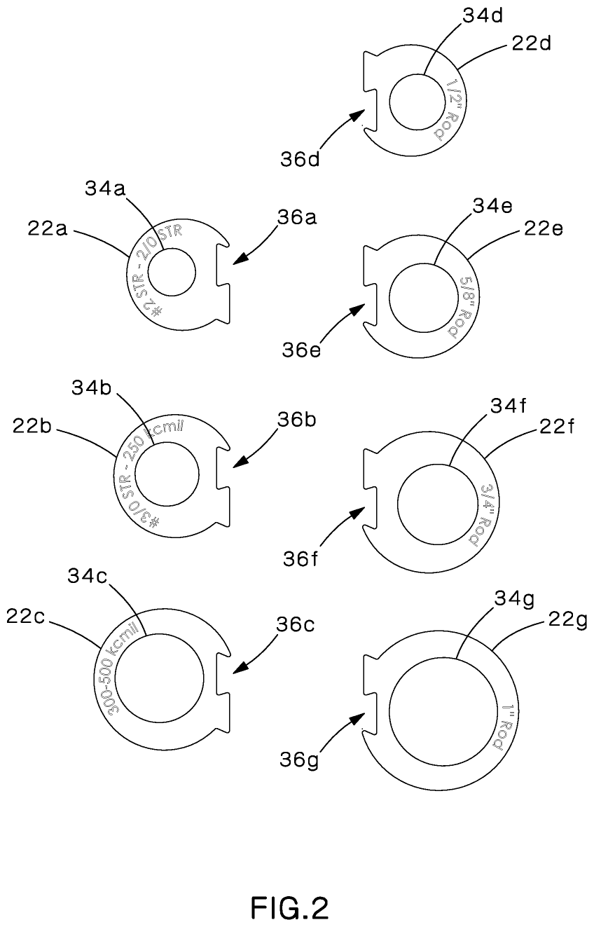

FIG. 2 depicts several differently sized grounding connectors 22a-22g. Each of the grounding connectors 22a-22g include the opening 34 and lock joint 36 as described above in relation to the grounding connector of FIG. 1. Grounding connectors 22a-22c may be configured to accept a wire. Grounding connectors 22d-22g may be configured to accept a grounding rod or wire.

As depicted in FIG. 2, grounding connectors 22a-22c are configured with different sized openings 34 in order to receive a variety of wire sizes. Grounding connector 22a may be configured with an opening 34a to accept a #2-gauge wire. In this instance, the opening 22a may be in the range of 0.2 inches to 0.4 inches in diameter. Grounding connector 22b may be configured with an opening 34b to accept a #3/0-gauge wire. In this instance, the opening 34b may be in the range of 0.4 inches to 0.75 inches in diameter. Grounding connector 22c may be configured with an opening 34c to accept a 300-500 kcmil wire. In this instance, the opening 22c may be in the range of 0.5 inches to 1 inches in diameter.

Further depicted in FIG. 2 are grounding connectors 22d-22g, which are configured with different sized openings 34 configured to receive a variety of rods. Grounding connector 22d may be configured with an opening 34d to accept a ½ inch rod. In this instance, the opening 34d may be in the range of 0.25 inches to 0.75 inches in diameter. Grounding connector 22e may be configured with an opening 34e to accept a ⅝ inch rod. In this instance, the opening 34e may be in the range of 0.375 inches to 0.875 inches in diameter. Grounding connector 22f may be configured with an opening 34f to accept a ¾ inch rod. In this instance, the opening 34f may be in the range of 0.5 inches to 1 inches in diameter. Grounding connector 22g may be configured with an opening 34g to accept a 1 inch rod. In this instance, the opening 34g may be in the range of 0.75 inches to 1.25 inches in diameter.

For grounding connectors 22a-22g, as the openings 34a-34g get larger to accommodate larger wires or rods, the body 32a-32g is enlarged to provide for sufficient material to support the opening 34a-34g. It is contemplated that a wall thickness 52 between the range of 0.125 to 0.3 inches may be maintained to provide sufficient material for the opening 34.

Despite the size of the body 32a-32g of each grounding connector 22a-22g in FIG. 2, the size of the lock joints 36 remain the same for each grounding connector 22a-22g, such that any of the lock joints 36a-36g of each of grounding connectors 22a-22g may mate with any other lock joint 36a-36g of grounding connectors 22a-22g. This allows any sized grounding connector 22a-22g to be interchangeably connected with another grounding connector 22a-22g.

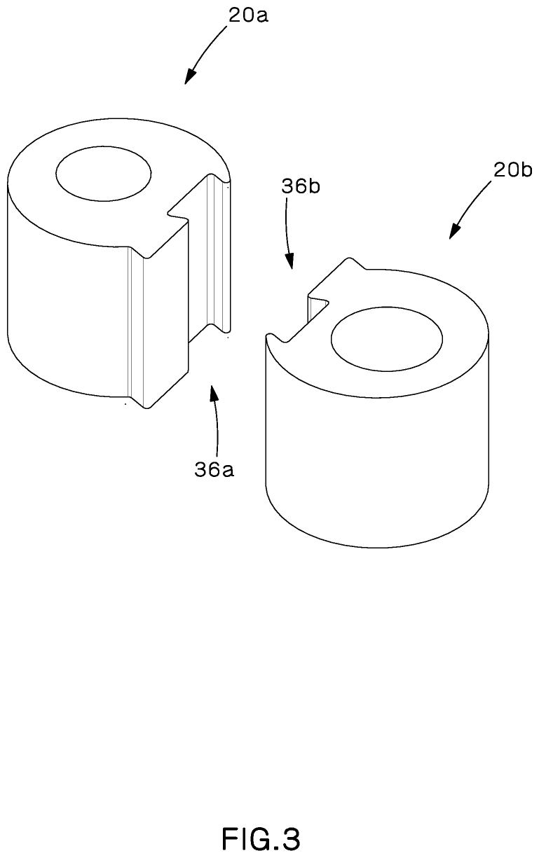

FIG. 3 depicts two grounding connectors 20a, 20b. The grounding connectors 20a, 20b are each the same grounding connectors as the grounding connector 20 of FIG. 1. Grounding connector 20b has been orientated 180 degrees from grounding connector 20a. As such, the locking joints 36a, 36b of the grounding connectors 20a, 20b of FIG. 3 are aligned to mate.

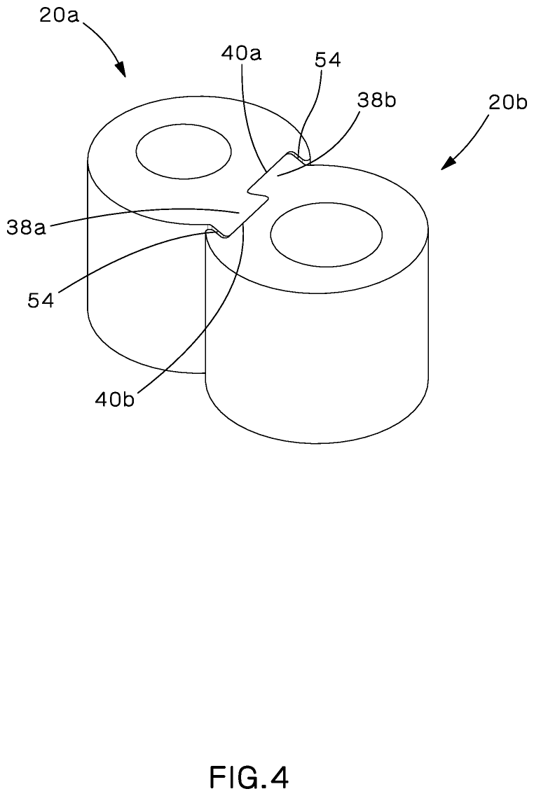

FIG. 4 depicts the grounding connectors 20a, 20b of FIG. 3 in a mated configuration. The protrusion 38a of grounding connector 20a is retained within the recess 40b of grounding connector 20b. Further, the protrusion 38b of grounding connector 20b is retained within the recess 40a of grounding connector 20a. The fit between the protrusions 38a, 38b and corresponding recess 40a, 40b may be configured to be a snug fit, but with sufficient allowance 54 between the protrusions 38a, 38b and the recesses 40a, 40b. The allowance 54 enables the grounding connectors 20a, 20b to be mated in a slidable connection.

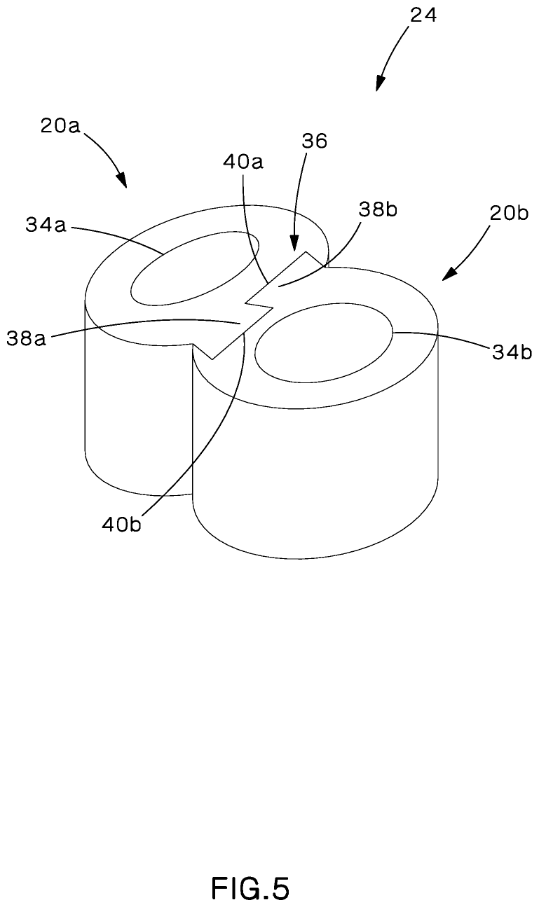

FIG. 5 depicts the grounding connectors 20a, 20b of FIG. 4 in a crimped and deformed configuration. In this configuration, the grounding connectors 20a, 20b have been compressed and deformed. The mated grounding connectors 20a, 20b are configured to be crimped in order to fix a wire or rod in place within the opening 34a, 34b of each grounding connector 20a, 20b. As depicted in FIG. 5, the openings 34a, 34b in each grounding connector 20a, 20b has been deformed to be elliptical in shape and to reduce the diameter across at least a portion of the opening 34a, 34b.

Further depicted in FIG. 5, is the interaction of the lock joints 36 of the grounding connectors 20a, 20b when the grounding connectors 20a, 20b are crimped together. Crimping the connectors 20a, 20b together also deforms the protrusions 38 within the recesses 40 of the lock joints 36. This deformation eliminates the allowance 54 of the lock joints 36 depicted in FIG. 4 of the grounding connectors 20a, 20b. The deformed protrusions 38 within the recesses 40 of FIG. 5 fix the grounding connectors 20a, 20b together to form a unitary grounding compression connector 24.

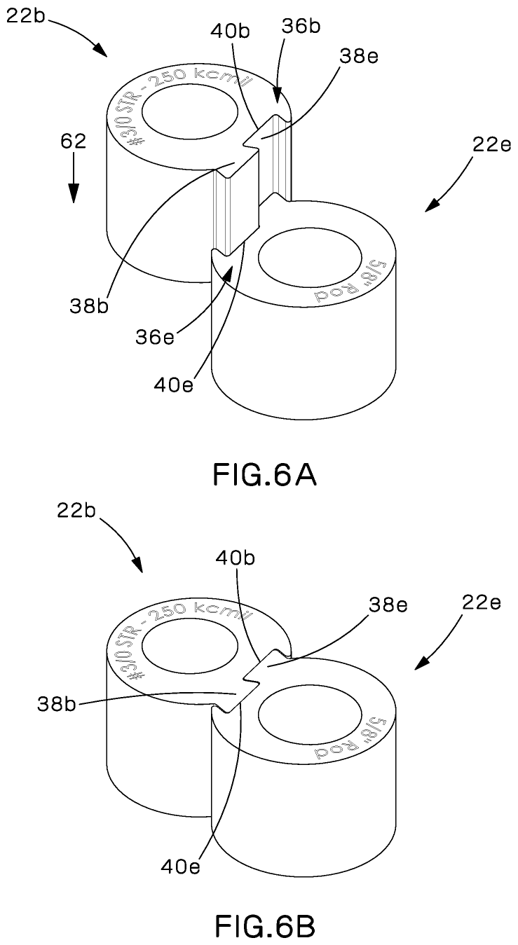

FIGS. 6A and 6B depict the assembling of two grounding connectors 22b, 22e of FIG. 2. The lock joint 36b of grounding connector 22b is aligned within the lock joint 36e of grounding connector 22e. The protrusion 38b of grounding connector 22b is inserted into the recess 40e of grounding connector 22e. At the same time, the protrusion 38e of grounding connector 22e is inserted into the recess 40b of grounding connector 22b. As depicted in FIG. 6A, grounding connector 22b may then be slid in the direction of the arrow 62. FIG. 6B depicts the two grounding connectors 22b, 22e in a mated configuration. The protrusion 38b of grounding connector 22b completely resides in the recess 40e of grounding connector 22e and the protrusion 38e of grounding connector 22e completely resides in the recess 40b of the grounding connector 22b.

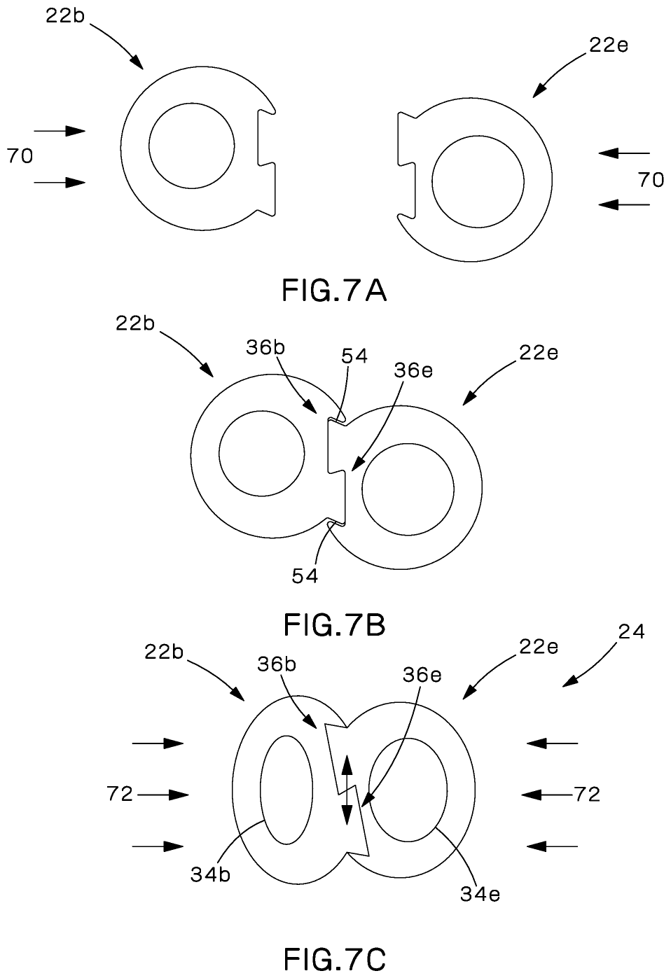

FIGS. 7A-7C depict a top perspective of the process of mating the grounding connectors 22b, 22e. In FIG. 7A, the two grounding connectors 22b, 22e are orientated for mating as depicted by arrows 70. FIG. 7B depicts the grounding connectors 22b, 22e in a mated relationship prior to crimping as shown by the allowance 54 in the lock joints 36b, 36e. FIG. 7C depicts the grounding connectors 22b, 22e after crimping. Force 72 has been applied to the grounding connectors 22b, 22e in the direction of the arrows. The openings 34b, 34e have been deformed and are configured to affix a wire or rod installed within as described below in relation to FIGS. 9 and 10 below. Also depicted, the protrusion 38b, 38e of each grounding connector 22b, 22e is deformed outwardly in the direction of arrow 74 within the respective recess 40b, 40e. This deformation eliminates the allowance 54 of the lock joints 36b, 36e depicted in FIG. 7B. Accordingly, the lock joints 36b, 36e have been deformed to fix the grounding connectors 22b, 22e together to form a unitary grounding compression connector 24.

FIGS. 8A-8C depict two significantly different sized grounding connectors 22a, 22g configured to be joined via the lock joints 36. As described above, the lock joint 36a, 22g of each of the grounding connectors 22a, 22g is configured such that the grounding connector 22g with a large diameter opening 34 may mate with the grounding connector 22a with a much smaller opening 34.

In FIG. 8A, the two grounding connectors 22a, 22g are orientated for mating as depicted by arrow 70. FIG. 8B depicts the grounding connectors 22a, 22g in a mated relationship prior to crimping, as shown by the allowances 54 in the lock joints 36a, 36g. FIG. 8C depicts the grounding connectors 22a, 22g after crimping. Force 72 has been applied to the grounding connectors 22a, 22g in the direction of the arrows. The openings 34a, 34g have been deformed to be elliptical in shape. This deformation reduces the diameter across at least a portion of the openings 34a, 34g.

Further, the lock joints 36a, 36g have been deformed to fix the grounding connectors 22a, 22g together to form a unitary grounding compression connector 24. The protrusion 38a, 38g of each grounding connector 22a, 22g is deformed outwardly in the direction of arrow 74 within the respective recess 40a, 40g. This deformation eliminates the allowances 54 of the lock joints 36a, 36g depicted in FIG. 8B, fixing the grounding connectors 22a, 22g together to form a unitary grounding compression connector 24.

FIG. 9 depicts a top isometric view of the grounding connectors 20a, 20b of FIGS. 3-5 with a wire 80 and grounding rod 82 installed therein. As depicted in FIG. 9, the wire 80 has been inserted into the opening 34a of grounding connector 20a. Further, the grounding rod 82 has been inserted into the opening 34b of grounding connector 20b. The grounding connectors 20a, 20b depicted in FIG. 9 have been crimped together to deform the openings 34a, 34b. The elliptical shape of the deformed openings 34a, 34b reduces the diameter across at least a portion of each of the openings 34a, 34b, thereby fixing the wire 80 and/or rod 82 in place within the respective grounding connector 20a, 20b.

The crimping of the grounding connector 20a, 20b also deforms the lock joints 36a, 36b as described above. As such, the grounding connectors 20a, 20b are fixed together as a unitary grounding compression connector 24.

FIG. 10 depicts a top isometric view of the grounding connectors 22a, 22g from FIGS. 8A-8C. As described above, the grounding connectors 20a, 20b are fixed together as a unitary grounding compression connector 24 with the wire 80 and rod 82 affixed within the openings 34a, 34g.

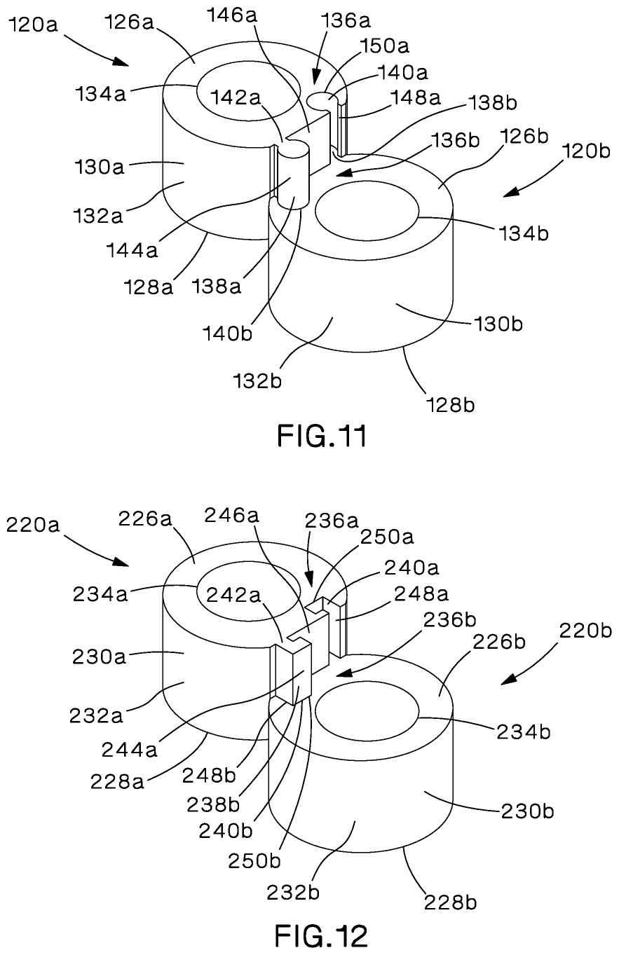

FIG. 11 depicts another example of the present invention. FIG. 11 depicts grounding connectors 120a, 120b, which are similar to the above described grounding connectors. Grounding connectors 120a, 120b include a first side 126, second side 128, and side wall 130 that define the body 132 as provided above in the description directed to the first side 26, second side 28, side wall 30, and body 32 of grounding connectors 20a, 20b. Grounding connectors 120a, 120b also include an opening 134 as described above. The description of the grounding connectors provided above applies to the description of the grounding connectors 120a, 120b as described in this paragraph.

Grounding connectors 120a, 120b depicted in FIG. 11 further include lock joints 136a, 136b. Each lock joint 136a, 136b includes the combination of a protrusion 138a, 138b and adjacent recess 140a, 140b. The protrusion 138a, 138b and recess 140a, 140b are separated by an intermediary wall 146a, 146b. The protrusion 140a, 140b is disposed on the side wall 130a, 130b from the first side 126a, 126b to the second side 128a, 128b. The protrusion includes a stem 142a, 142b and a head 144a, 144b. The stem 142a, 142b may extend out from the side wall 130a, 130b at a right angle. The stem 142a, 142b has a rectangular cross-sectional shape. At an end of the stem 142a, 142b is the head 144a, 144b. The head 144a, 144b has a circular cross-sectional shape. The stem 142a, 142b offsets the head 144a, 144b away from the side wall 130a, 130b.

The recess 140a, 140b is a cut-out within the body 132a, 132b in the same cross-sectional configuration as the protrusion 138a, 138b. The recess 140a, 140b extends from the first side 126a, 126b to the second side 128a, 126b along the side wall 130a, 130b. The recess 140a, 140b includes a stem cut-out 148a, 148b and a head cut-out 150a, 150b. The stem cut-out 148a, 148b may extend into the body 132a, 132b from the side wall 130a, 130b at a right angle. The stem cut-out 148a, 148b has a rectangular cross-sectional shape. At an end of the stem cut-out 148a, 148b is the head cut-out 150a, 150b. The head cut-out 150a, 150b has a circular cross-sectional shape. The stem cut-out 148a, 148b offsets the head cut-out 150a, 150b away from the side wall 130a, 130b.

The shape and dimensions of the protrusion 138a, 138b are configured to correspond to the recess 140a, 140b. The size and shape of the protrusion 138a, 138b is configured to be slightly smaller than the size and shape of the recess 140a, 140b of the grounding connectors 120a, 120b. The shape and size relationship between the protrusion 138a, 138b and recess 140a, 140b facilitate on the grounding connectors 120a, 120b is such that the grounding connector is symmetrical and may mate with other grounding connectors with the same lock joint 136a, 136b configuration as depicted in FIG. 11.

FIG. 12 depicts a further example of the present invention. FIG. 12 depicts grounding connectors 220a, 220b, which are similar to the above described grounding connectors. Grounding connectors 220a, 220b include a first side 226a, 226b, second side 228a, 228b, and side wall 230a, 230b that define the body 232a, 232b as provided above in the description directed to the first side 26a, 26b, second side 28a, 28b, side wall 30a, 30b, and body 32a, 32b of grounding connectors 20a, 20b. Grounding connectors 220a, 220b also include an opening 234a, 234b as described above. The description of the grounding connectors provided above relates to the description of the grounding connectors 220a, 220b as described in this paragraph.

Grounding connectors 220a, 220b depicted in FIG. 12 further include lock joints 236a, 236b. The lock joint 236a, 236b includes the combination of a protrusion 238a, 238 and adjacent recess 240a, 240b. The protrusion 238a, 238b and recess 240a, 240b are separated by an intermediary wall 246a, 246b.

The protrusion 238a, 238b is disposed on the side wall 230a, 230b from the first side 226a, 226b to the second side 228a, 228b. The protrusion 228a, 228b is L-shaped. The protrusion includes a stem 242a, 242b and a head 244a, 244b. The stem 242a, 242b offsets the head 244a, 244b away from the side wall 230a, 230b. The stem 242a, 242b may extend out from the side wall 226a, 226b at a right angle. The stem cut 242a, 242b has a rectangular cross-sectional shape. At an end of the stem 242a, 242b is the head 244a, 244b. The head 244a, 244b extends across a portion of the intermediary wall 246a, 246b towards the recess. The head 244a, 244b has a rectangular shaped cross-section.

The recess 240a, 240b is a cut-out within the body 232a, 232b in the same cross-sectional configuration as the protrusion 238a, 238b. The recess 240a, 240b extends from the first side 226a, 226b to the second side 228a, 228b along the side wall 230a, 230b. The recess 240a, 240b includes a stem cut-out 248a, 248b and a head cut-out 250a, 250b. The stem cut-out 248a, 248b may extend into the body 232a, 232b from the side wall 226a, 226b at a right angle. The stem cut-out 248a, 248b has a rectangular cross-sectional shape. At an end of the stem 242a, 242b is the head cut-out 250a, 250b. The head cut-out 250a, 250b has a rectangular cross-sectional shape. The stem cut-out 248a, 248b offsets the head cut-out 250a, 250b away from the side wall 230a, 230b.

The shape and dimensions of the protrusion 238a, 238b are configured to correspond to the recess 240a, 240b. The size and shape of the protrusion 238a, 238b is configured to be slightly smaller than the size and shape of the recess 240a, 240b of the grounding connectors 220a, 220b. The shape and size relationship between the protrusion 238a, 238b and recess 240a, 240b facilitate on the grounding connectors 220a, 220b is such that the grounding connector is symmetrical and may mate with other grounding connectors with the same lock joint 236a, 236b configuration as depicted in FIG. 12.

The grounding connector of the present invention may be constructed of electrically conductive material, such as copper. However, it is likewise contemplated that the grounding connector may be made of any suitable material or element that will withstand a crimping operation.

The illustrations of the embodiments described herein are intended to provide a general understanding of the structure of the various examples. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A grounding connector for securing a wire or rod therein, the grounding connector comprising:
a body including a first side and a second side and a mid-section extending therebetween,
wherein an opening extends through the body from the first side to the second side, and
wherein the body includes a lock joint configured to join the grounding connector with a second grounding connector, the lock joint including a recess inset into the mid-section of the body and a protrusion adjacent the recess extending from the mid-section.

2. The grounding connector of claim 1, wherein the lock joint is configured to slidably connect to the second grounding connector.

3. The grounding connector of claim 1, wherein the opening is configured to accept a wire or rod.

4. The grounding connector of claim 3, wherein the grounding connector is configured to deform and reduce the diameter across at least a portion of the opening for securing the wire or rod therein.

5. The grounding connector of claim 1, wherein the protrusion includes a first outer wall extending from the body, an inner wall extending from the body, and a first base wall extending therebetween, where a first distance between the first outer wall and the inner wall along the base wall is greater than a second distance between the outer wall and the inner wall along the body.

6. The grounding connector of claim 5, wherein the recess includes a second outer wall extending into the body, the inner wall of the protrusion, and a second base wall extending therebetween, where a third distance between the second outer wall and the inner wall along the second base wall is greater than a fourth distance between the second outer wall and the inner wall along adjacent the second base wall.

7. A compression connector for securing wires or rods therein, the compression connector comprising:
a first grounding connector including a body including a first side and a second side and a mid-section extending therebetween, wherein an opening extends through the body from the first side to the second side and wherein the body includes a first lock joint, and
a second grounding connector including a body including a first side and a second side and a mid-section extending therebetween, wherein an opening extends through the body from the first side to the second side and wherein the body includes a second lock joint;
wherein the first lock joint of the first grounding connector is removably mated to the second lock joint of the second grounding connector.

8. The compression connector of claim 7, wherein the opening of first grounding connector is larger than the opening of the second grounding connector.

9. The compression connector of claim 7, wherein the first and second lock joints include a protrusion and a recess.

10. The compression connector of claim 9, wherein the protrusions extend out from the body and the recess resides within the body.

11. The grounding connector of claim 7, wherein the first lock joint and second lock joint are configured to slidably mate.

12. The grounding connector of claim 7, wherein the first lock joint of the first grounding connector includes a first recess inset into a mid-section of the body and a first protrusion adjacent the first recess extending from the mid-section.

13. The grounding connector of claim 7, wherein the second lock joint of the second grounding connector includes a second recess inset into a mid-section of the body and a second protrusion adjacent the second recess extending from the mid-section.

14. The grounding connector of claim 13, wherein the first protrusion and second protrusion each include a first outer wall extending from the body, an inner wall extending from the body, and a first base wall extending therebetween, where a first distance between the first outer wall and the inner wall along the base wall is greater than a second distance between the outer wall and the inner wall along adjacent the second base wall.

15. The grounding connector of claim 14, wherein the first recess and second recess each include a second outer wall extending into the body, the inner wall of the protrusion, and a second base wall extending therebetween, where a third distance between the second outer wall and the inner wall along the second base wall is greater than a fourth distance between the second outer wall and the inner wall along the body.

16. A method of forming a compression connector, the method comprising:
joining a first lock joint of a first grounding connector to a second lock joint of a second grounding connector,
inserting a wire into an opening in the first grounding connector,
inserting a rod into an opening in the second grounding connector,
crimping the joined first grounding connector and second grounding connector, and
deforming the first grounding connector and the second grounding connector, thereby locking the first grounding connector to the second grounding connector and securing the wire and grounding rod in place.
